(19) United States
(12) Patent Application Publication
(10) Pub. No.: US 2005/0174474 A1
(43) Pub. Date: Aug. 11, 2005

(54) Image-taking apparatus

(75) Inventor: Yasushi Hasegawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/036,826

(22) Filed: Jan. 14, 2005

(30) Foreign Application Priority Data
Feb. 5, 2004 (JP) 2004-029174

(51) Int. Cl. H04N 5/222

(52) U.S. Cl. 348/370

(57) ABSTRACT

An image-taking apparatus is configured to carry out flashmatic control during flash photographing, wherein the light emission amount of light emission sections, the aperture diameter of an aperture diaphragm and the gain applied to an image signal in an AGC circuit are determined depending on the distance to the object. When the distance to the object, detected by a distance measuring device, is a predetermined value or less, at least one of the light emission amount of the light emission sections, the aperture diameter of the aperture diaphragm and the gain applied to the image signal is corrected to a value larger than the value determined by the flashmatic control, and flash photographing is carried out.

This application is based on application No. 2004-29174 filed in Japan, the content of which is hereby incorporated by reference.

### FIELD OF THE INVENTION

The present invention relates to an image-taking apparatus, such as a digital camera, and more particularly, to a control technology for flash photographing.

### DESCRIPTION OF THE RELATED ART

Conventionally, an image-taking apparatus for carrying out exposure control so that the exposure state in the distance measurement area or focus detection area in an image becomes proper in order to solve the problem of unevenness in flashlight distribution (unevenness in illumination) during flash photographing has been known.

Generally, in an image-taking apparatus, the optical axis of the image-taking lens cannot be aligned with the optical axis of the flashlight emission section. Hence, in a short distance region (macro photography region) wherein the distance to the object is approximately several tens of centimeters, the influence of the misalignment between the optical axes of the image-taking lens and the light emission section becomes great, and the unevenness in light distribution, a state wherein the central portion of an image becomes significantly darker than the peripheral portion thereof, occurs significantly.

Therefore, when flash photographing is carried out in a short distance region using the conventional image-taking apparatus, the central portion of the image becomes dark, thereby causing a problem of being unable to obtain an optimum image.

### SUMMARY OF THE INVENTION

The present invention is intended to provide an image-taking apparatus capable of carrying out photographing so that the central portion of an image has optimum brightness even when the object located in a short distance is flash-photographed.

In order to accomplish the above-mentioned object, an aspect of the present invention provides an image-taking apparatus comprising an optical system, having an aperture stop, for leading the light from the object to an image-taking device, a distance measuring device for detecting the distance to the object, and a light emission device for emitting flashlight, the image-taking apparatus being configured to carry out flash photographing under flashmatic control, wherein when the distance to the object, detected by the distance measuring device, is a predetermined value or less, at least one of the light emission amount of the light emission device, the aperture diameter of the aperture stop and the gain applied to the image signal obtained from the image-taking device is corrected to a value larger than the value determined by the flashmatic control, and flash photographing is carried out.

The image-taking apparatus is configured to carry out flash photographing under the flashmatic control. When the distance to the object, detected by the distance measuring device, is the predetermined value or less, at least one of the light emission amount of the light emission device, the aperture diameter of the aperture stop and the gain applied to the image signal obtained from the image-taking device is corrected to a value larger than the value determined by the flashmatic control, and flash photographing is carried out.

Hence, even when the object is in a short distance, photographing can be carried out while the unevenness in light distribution by the light emission sections is suppressed and optimum brightness is provided at the central portion of the image.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a perspective view showing the schematic configuration of an image-taking apparatus;

FIG. 2 is a perspective view showing the schematic configuration of the image-taking apparatus, all sections being mounted on the camera body thereof;

FIG. 3 is a block diagram showing the internal configuration of the image-taking apparatus;

FIG. 4 is a graph showing the distance to the object, the distance being identified by the position of the focusing lens unit;

FIG. 5 is a graph showing the relationship between the distance to the object and “DV error;”

FIGS. 6A to 6C are views showing the illumination state of the object when the distance to the object is large;

FIGS. 7A to 7C are views showing the illumination state of the object when the distance to the object is small;

FIGS. 8A to 8C are views showing the illumination state of the object when the distance to the object is large;

FIGS. 9A to 9C are views showing the illumination state of the object when the distance to the object is small;

FIGS. 10A to 10C are views showing the change in the installation angle of the light emission sections in the image-taking apparatus;

FIG. 11 is a flowchart showing the operation procedure of the image-taking apparatus;

FIG. 12 is a flowchart showing the operation procedure of the image-taking apparatus; and

FIG. 13 is a table showing the relationship between the distance to the object and the correction amounts of a light emission amount.

### DETAILED DESCRIPTION OF THE PREFERRED EMBODIMENTS

An embodiment in accordance with the present invention will be described below in detail referring to the drawings.

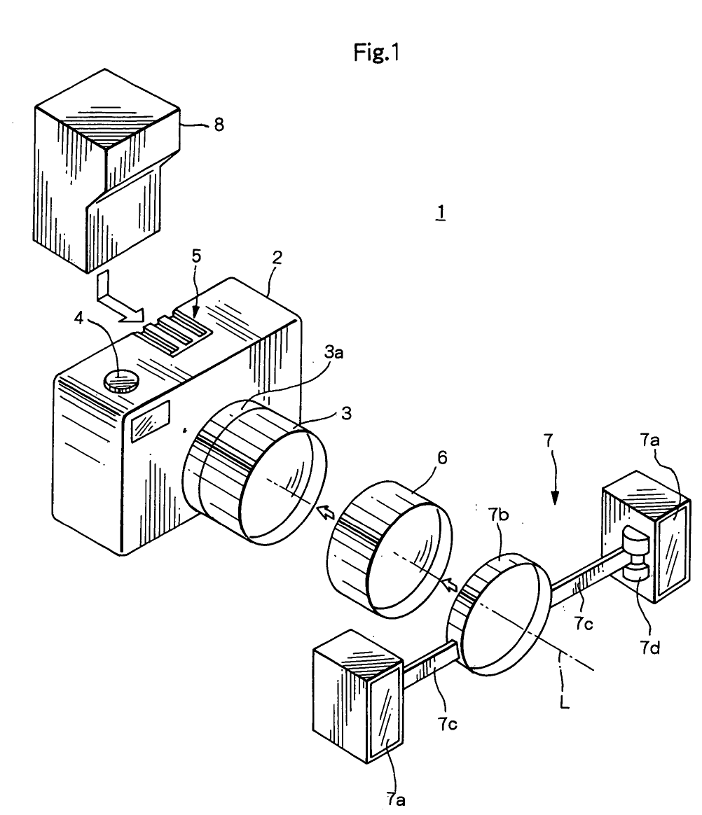

As shown in FIG. 1, in the camera body 2 of an image-taking apparatus 1, a taking lens 3 is disposed on the front side thereof. On the upper side thereof, a shutter button 4 and a flash device connection section (accessory shoe) 5 to which an external electronic flash device is connected are disposed.

The taking lens 3 is an optical system for photographing a general object, and its photographable range is in the range from the most proximal position of approximately several tens of centimeters ahead of the taking lens to the infinite distance. A focusing lens unit for carrying out focus adjustment and an aperture diaphragm are provided inside the taking lens 3. The image of the object located at a given position in the range from the most proximal position to the infinite distance can be brought into an in-focus state properly by moving the focusing lens unit along the optical axis L.

A focus ring 3a is provided for the taking lens 3. The focusing lens unit inside the taking lens 3 can be moved along the optical axis L when the user manually turns the focus ring 3a, whereby the focus state of the object image can be adjusted manually. In addition, the image-taking apparatus 1 is also provided with an automatic focusing function. When the user sets the shutter button 4 in its half-pressed state for example, automatic focusing control starts, and the object image is automatically brought into an in-focus state.

The shutter button 4 is provided with a push switch capable of distinguishing between the two states thereof, that is, the half-pressed state and the fully-pressed state, and capable of detecting the respective states. At the time of the half-pressed state for example, the above-mentioned automatic focusing control is carried out, and at the time of the fully-pressed state, photographing operation for image recording starts.

The front end, that is, the object-side end, of the taking lens 3 is configured so that another optical lens can be mounted thereon. In this embodiment, a close-up lens 6 is mounted on the front end of the taking lens 3. The close-up lens 6 is an optical lens for short distance photographing and is an optical system for converting the photographable range of the image-taking apparatus 1 into a short distance region from several tens of centimeters to several meters, that is, a macro region. The most proximal position of the macro region is shorter to some extent than the proximal position of the photographable range of the taking lens 3 itself.

Hence, the image-taking apparatus 1 can properly bring the image of the object located within the short distance region into an in-focus state by using the close-up lens 6 mounted on the taking lens 3. However, the image of the object located outside the short distance region cannot be properly brought into an in-focus state even when the focusing lens unit is moved. In other words, the optical system of the image-taking apparatus 1 is configured so as to be suited for short-distance photographing by mounting the close-up lens 6 on the taking lens 3.

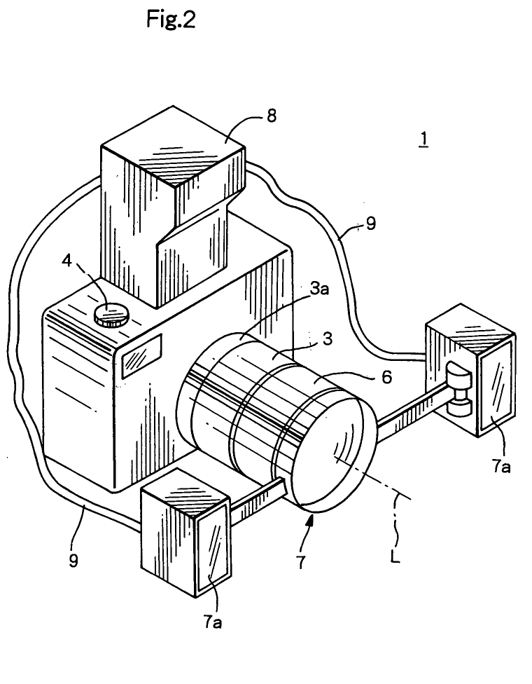

Furthermore, the front end of the close-up lens 6 is configured so that an electronic flash device 7 for short-distance photographing can be mounted thereon. The electronic flash device 7 comprises light emission sections 7a for emitting flashlight, a ring member 7b mounted on the front end of the close-up lens 6, and arms 7c connected to the ring member 7b to support the light emission sections 7a. In the example shown in FIGS. 1 and 2, a pair of light emission sections 7a are disposed at positions symmetrical with respect to the optical axis L and equidistant from the optical axis L. Since the pair of light emission sections 7a are mounted at positions symmetrical with respect to the optical axis L as described above, the unevenness in light distribution during flash photographing can be reduced.

Moreover, each light emission section 7a is connected to the arm 7c via a rotating member 7d. The installation angle of the light emission section 7a with respect to the optical axis L can be adjusted stepwise or steplessly by the rotation of the rotating member 7d. The rotating member 7d may be driven by a motor built in the light emission section 7a to automatically change the installation angle of the light emission section 7a or may be manually rotated by the user.

Still further, the installation position of the light emission section 7a with respect to the ring member 7b can be adjusted by changing the installation position of the arm 7c with respect to the ring member 7b or by replacing the arm 7c with an arm having a different length, for example.

A flash control section 8 for controlling the light emission of the electronic flash device 7 is mounted on the flash device connection section 5 of the camera body 2. A power source for supplying light emission power to the light emission sections 7a and other related components are built in the flash control section 8. The flash control section 8 can cause the light emission sections 7a to emit light when the flash control section 8 is connected to the light emission sections 7a via cables 9 as shown in FIG. 2.

In addition, as shown in FIG. 2, the close-up lens 6 is mounted on the taking lens 3, the electronic flash device 7 is mounted on the close-up lens 6, and the flash control section 8 is installed on the camera body 2, whereby the image-taking apparatus 1 has a hardware configuration capable of short-distance flash photographing. However, the image-taking apparatus 1 configured as described above may be formed integrally in advance.

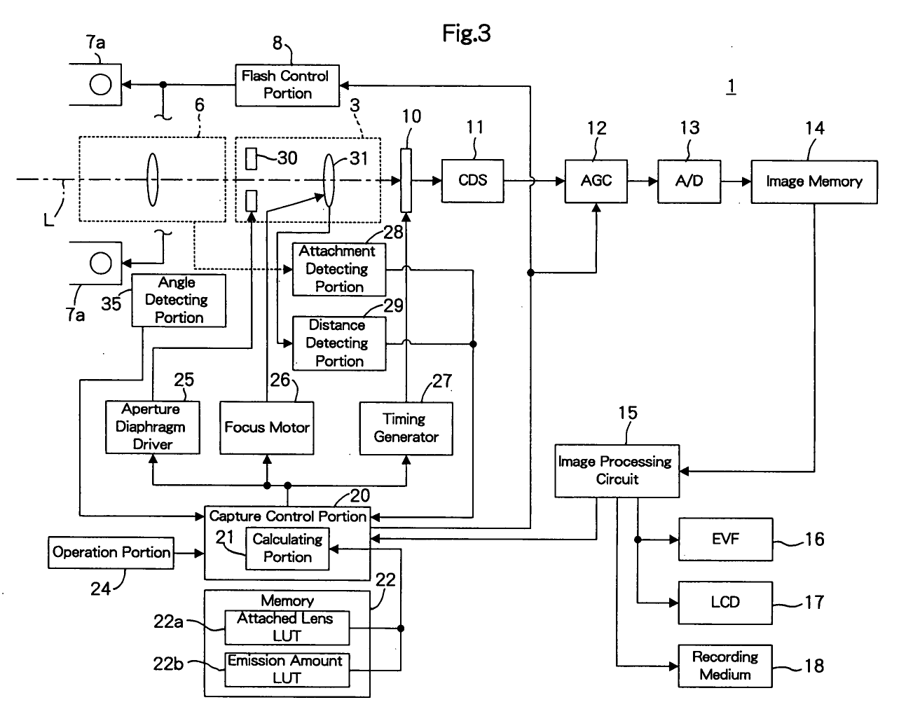

FIG. 3 is a block diagram showing the internal configuration of the image-taking apparatus wherein the close-up lens 6, the electronic flash device 7 and the flash control section 8 are installed on the camera body 2.

As described above, the taking lens 3 comprises an aperture diaphragm 30 whose aperture diameter is adjustable and a focusing lens unit 31 for adjusting the focus state of the object image formed on an image-taking device 10. The image-taking device 10 is a photoelectric conversion device comprising an image sensor such as a CCD, a CMOS sensor or the like and receives light incident via the close-up lens 6 and the taking lens 3 and generates an electrical image signal.

The image signal generated by the image-taking device 10 is subjected to predetermined signal processing in a CDS circuit. (correlated double sampling circuit). 11, and a gain is applied to the image signal in an AGC circuit (automatic gain control circuit) 12, whereby the level of the signal is adjusted. The gain applied in the AGC circuit 12 is used to adjust the sensitivity of the image-taking device 10, and its value is set by a photographing control section 20. The image signal whose level has been adjusted by the AGC circuit 12 is converted by an A/D converter (analog to digital converter) 13 from an analog signal to a digital signal and then stored temporarily in an image memory 14.

An image-processing circuit 15 is an arithmetic operation device configured to capture the image stored in the image memory 14 and to carry out various image processing. The image-processing circuit 15 outputs the image signal generated by the various image processing to an electronic viewfinder 16, a liquid crystal display 17, a recording medium 18 or the photographing control section 20. For example, the electronic viewfinder 16 and the liquid crystal display 17 are provided on the rear side of the image-taking apparatus 1 so that the user can check the image.

Image processing suited for each display device is carried out so that the image obtained by photographing is displayed on the display device. In addition, when the image signal obtained by photographing operation is recorded on the recording medium 18, such as a memory card, the image signal is subjected to compression processing and the like and then recorded on the recording medium 18. Furthermore, at the time of automatic focusing, a partial image corresponding to a predetermined focus region is extracted from the image obtained from the image-taking device 10 and output to the photographing control section 20.

The photographing control section 20 comprises a microcomputer or the like and controls the photographing operations of the image-taking apparatus 1 collectively. When the close-up lens 6 is not mounted on the image-taking apparatus 1, the photographing control section 20 carries out control so that the object located at a given position in the range from the most proximal position to the infinite distance can be photographed in an optimum state.

Furthermore, when the close-up lens 6 is mounted on the image-taking apparatus 1, the photographing control section 20 carries out control so that the object located within the short distance region determined by the close-up lens 6 can be photographed in an optimum state. In particular, when flash photographing is carried out using the image-taking apparatus 1, the amount of flashlight emission and the like are determined by flashmatic control, and various sections are controlled so that the object is photographed at a constant brightness at all times regardless of the distance to the object. The details of the flashmatic control will be described later.

In addition, at the time of automatic focusing, the photographing control section 20 moves the focusing lens unit 31 at predetermined pitches, calculates the contrast of a partial image being input in sequence from the image-processing circuit 15 and identifies the position wherein the contrast is the maximum as an in-focus position. Finally, the photographing control section 20 moves the focusing lens unit 31 to the in-focus position, whereby the object image to be formed on the image-taking device 10 is brought into an in-focus state.

An aperture driver 25 drives the aperture diaphragm 30 provided in the taking lens 3 to adjust the aperture diameter of the aperture diaphragm 30. The driver drives the aperture diaphragm 30 on the basis of instructions from the photographing control section 20.

A focus motor 26 moves the focusing lens unit 31 provided in the taking lens 3 along the optical axis L at predetermined pitches at the time of automatic focusing. The motor drives the focusing lens unit 31 on the basis of the movement direction and movement distance instructions issued from the photographing control section 20. However, the focusing lens unit 31 is also moved along the optical axis L when the user manually operates the focusing ring 3a as described above.

A timing generator 27 transmits exposure start and end timing signals to the image-taking device 10 on the basis of the photographing instructions from the photographing control section 20.

A mounting detection section 28 is a detector for detecting that another optical lens is mounted on the taking lens 3. After detecting the lens mounted on the taking lens 3, the mounting detection section 28 identifies the type of the lens and other information. The information detected by the mounting detection section.28 is transmitted to the photographing control section 20. Hence, when the close-up lens 6 is mounted on the taking lens 3, the mounting detection section 28 transmits, to the photographing control section 20, a signal indicating that the close-up lens 6 has been mounted.

A distance measuring section 29 generates information regarding the distance to the object on the basis of the focus state of the object by virtue of the focusing lens unit 31. More specifically, when the position of the focusing lens unit 31 is determined by automatic focusing or manual focusing, the distance measuring section 29 determines, depending on the position of the focusing lens unit 31, where the object is located within the photographable range of the taking lens 3 and generates distance information.

Hence, on the basis of the optical characteristics of the taking lens 3, the distance measuring section 29 identifies where the object is located within the photographable range (in other words, in the range from the most proximal position to the infinite distance). The distance information detected by the distance measuring section 29 is then output to the photographing control section 20.

In the state wherein the close-up lens 6 is mounted on the taking lens 3, the optical characteristics of the image-taking apparatus 1 change differently, and the distance information detected by the distance measuring section 29 becomes inaccurate. Hence, when the close-up lens 6 is mounted, the distance information obtained by the distance measuring section 29 is corrected by the photographing control section 20 as described later.

An operation section 24 is an operation member at which the user carries out various operations to input data to the image-taking apparatus 1. The operation section 24 is provided with the above-mentioned shutter button 4 and also provided with various operation buttons (not shown) disposed on the rear side or other portions of the image-taking apparatus 1.

A memory 22 is used to store control data for use in the photographing control section 20. A mounted lens LUT (lookup table) 22a and an emission amount correction LUT 22b, for example, are stored therein. In the mounted lens LUT 22a, information regarding an optical lens such as a conversion lens, which is mounted on the taking lens 3, is stored as table data. In this embodiment, the information regarding the close-up lens 6 is stored. Furthermore, in the emission amount correction LUT 22b, information for correcting the unevenness in flashlight distribution owing to the misalignment between the light emission sections 7a and the optical axis L during short-distance photographing is stored.

An angle detection section 35 is provided inside the light emission section 7a of the electronic flash device 7, for example. The angle detection section 35 is configured to detect the installation angle of the light emission section 7a with respect to the optical axis L and to transmit the installation angle as angle information to the photographing control section 20.

With the above-mentioned configuration, in the state wherein the mounting detection section 28 has detected the mounting of the close-up lens 6 and the flash control section 8 has been mounted on the flash device connection section 5 and when the user has made the setting for flash photographing, the photographing control section 20 carries out flashmatic control in response to the full-pressing operation of the shutter button 4.

The flashmatic control will be described herein. The flashmatic control is control for carrying out flash photographing so that the object has a constant brightness as viewed from the image-taking device 10. With this control, when the flashlight emission amount from the light emission sections 7a is IV, when the aperture value of the aperture diaphragm 30 is AV, when the sensitivity (gain) of the AGC circuit 12 is SV and when the distance (object distance) from the image-taking apparatus 1 to the object is DV, at least one of the light emission amount IV, the aperture value AV and the sensitivity SV is determined so that the following relationship:
IV=AV+DV−SV+5 (1)
is established among these, and flash photographing is carried out by applying the values. The above-mentioned values, AV and SV, are values represented according to APEX (Additive System of Photographic Exposure). Furthermore, IV and DV are defined as follows according to the definitions of APEX.
(\sqrt{2})^{IV}=G No
(\sqrt{2})^{DV}=d

Here, “G No.” is Guide Number of the electronic flash device, and “d” is object distance represented by “meter”.

When the aperture value AV and the sensitivity SV have been determined in advance for example, the flashlight emission amount IV is controlled so as to increase as the object distance DV, that is, the distance from the image-taking apparatus 1 to the object, is larger (in other words, as the object is farther from the image-taking apparatus 1). On the other hand, as the object distance DV is smaller, the emission amount IV is controlled so as to decrease. As a result, the light emission amount by the light emission sections 7a is controlled so that the object viewed from the image-taking device 10 has a constant brightness at all times.

Furthermore, when the flashlight emission amount by the light emission sections 7a is decreased gradually and when the light emission amount becomes a lower limit value or less accurate light emission amount control cannot be carried out. In this case, the flashlight emission amount is fixed at the lower limit value, and control is carried out by adjusting the aperture value AV or the sensitivity SV so that the above-mentioned mathematical expression 1 is satisfied. When the object is located in the most proximal position within the photographable range of the image-taking device 1 so that when the object distance DV is a very small value, the light emission amount IV may become the lower limit value or less.

Hence, the-light emission amount IV is fixed at the lower limit value, and the aperture value AV is updated to a larger value or the sensitivity SV is updated to a smaller value on the basis of the above-mentioned mathematical expression 1. Therefore, even in a situation wherein the light emission amount IV cannot be decreased, the optical components led to the image-taking device 10 can be decreased by making the aperture diameter of the aperture diaphragm 30 smaller, or the level of the image signal can be lowered by decreasing the gain of the AGC circuit 12.

Hence, in the image-taking device 1 on which the close-up lens 6 is mounted, when short-distance flash photographing is done, the flashmatic control is carried out, whereby the photographing can be carried out so that the object viewed from the image-taking device 10 has a constant brightness at all times, without requiring preliminary light emission from the light emission sections 7a.

In light control wherein light is emitted preliminarily and the reflected light thereof is measured to determine the flashlight emission amount at the time of recording/photographing, overexposure is generally apt to occur on the entire image in the case of short-distance photographing. Such overexposure on the entire photographed image can be prevented by carrying out the above-mentioned flashmatic control.

Furthermore, the flashmatic control is flash control not susceptible to the reflectivity of the object. Therefore, the colors of the object can be faithfully reproduced on the photographed image. Since importance is placed on color reproduction in the case of short-distance photographing in particular, the flashmatic control is flash control suited for short-distance photographing.

When the above-mentioned flashmatic control is carried out, the object distance DV is required to be obtained accurately in consideration of the above-mentioned mathematical expression 1. This embodiment is configured so that the flashmatic control is carried out after accurate distance information is obtained by correcting the distance information detected by the distance measuring section 29.

The distance measuring section 29 calculates the distance information on the basis of the optical characteristics of the taking lens 3 being used singly as described above. Hence, in the state wherein the close-up lens 6 is mounted, the distance information obtained from the distance measuring section 29 cannot be directly used for the flashmatic control. This is because the distance measuring section 29 obtains the distance information on the assumption that the photographable range of the image-taking apparatus 1 is the range from the most proximal position to the infinite distance and because in the state wherein the close-up lens 6 is mounted, the photographable range is changed and the region wherein the object image can be brought into an in-focus state by moving the focusing lens unit 31 is limited to the short distance region.

Therefore, correction information for correcting the distance information detected by the distance measuring section 29 on the basis of the optical characteristics of the close-up lens 6 is stored as the mounted lens LUT 22a in the memory 22 in accordance with this embodiment. When distance information X is input from the distance measuring section 29, the arithmetic operation section 21 of the photographing control section 20 reads the mounted lens LUT 22a from the memory 22 to obtain the correction information and carries out predetermined arithmetic processing. As a result, the distance information X is corrected to distance information Xc suited for the optical characteristics obtained in the state wherein the close-up lens 6 is mounted.

For example, when it is assumed that the focal length “F” of the close-up lens 6 has been stored as correction information, the distance information Xc after the correction is obtained by the following arithmetic operation:
Xc=X×F/(X+F) (2)
However, the arithmetic operation of the mathematical expression 2 may be done in advance, and the relationship between the distance information X before the correction and the distance information Xc after the correction may be stored as table data in the mounted lens LUT 22a.

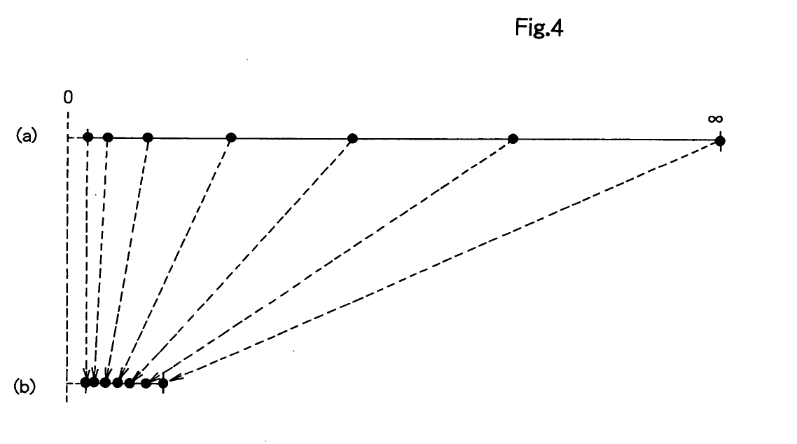

FIG. 4 is a graph showing the distance to the object, the distance being identified by the position of the focusing lens unit 31. In the graph, the region indicated by a solid line is the photographable range. Black points indicate the object distances corresponding to the stop positions of the focusing lens unit 31, respectively.

For example, when the close-up lens 6 is not mounted on the image-taking apparatus 1, the location of the object is identified in the range from the most proximal position to the infinite distance depending on the position of the focusing lens unit. 31 as shown in (a) of FIG. 4. On the other hand, when the close-up lens 6 is mounted on the image-taking apparatus 1, the photographable range is shifted and limited to the short distance region as shown in (b) of FIG. 4.

When it is assumed herein that the focusing lens unit 31 has seven stop positions as shown in FIG. 4 for the sake of simplicity, and when the close-up lens 6 is mounted, these seven lens positions respectively indicate the object distances within the short distance region (see (b) of FIG. 4).

Hence, when the close-up lens 6 is mounted, the photographing control section 20 corrects the distance information detected by the distance measuring section 29 on the basis of the information regarding the close-up lens 6, whereby the object distance in the short distance region can be obtained at a high resolution.

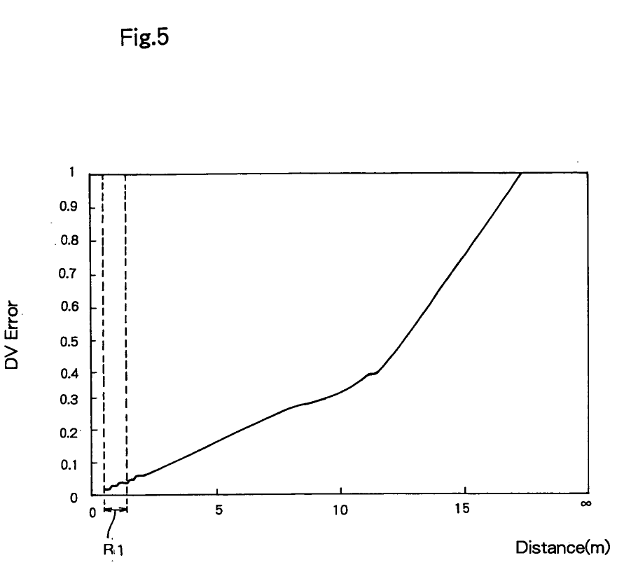

Then, the object distance DV defined in accordance with APEX is calculated on the basis of the distance information Xc corrected by the arithmetic operation section 21 of the photographing control section 20. The object distance DV obtained at this time has a very accurate value with little error. FIG. 5 is a graph showing the relationship between the distance (meter) to the object and an error occurred when the object distance DV is obtained from the distance (meter), that is, a DV error.

It is understood that the DV error reduces in the short distance region R1. When photographing is carried out in the photographable range limited to the short distance region R1 by using the close-up lens 6 just as in the case of this embodiment, the object distance DV obtained by the distance measuring section 29 becomes highly accurate, whereby the DV error occurred when the object distance DV is obtained is suppressed within a very small range by the flashmatic control. Hence, the object distance DV being highly accurate and having little error is obtained.

After the object distance DV based on the corrected distance information Xc is obtained, a judgment is made as to whether or not the object distance DV is a predetermined value or less. The fact that the object distance DV is a predetermined value or less means that the distance from the image-taking apparatus 1 to the object is a predetermined interval or less. This predetermined value is determined on the basis of the position wherein the unevenness in light distribution becomes conspicuous when the light emission sections 7a emit light.

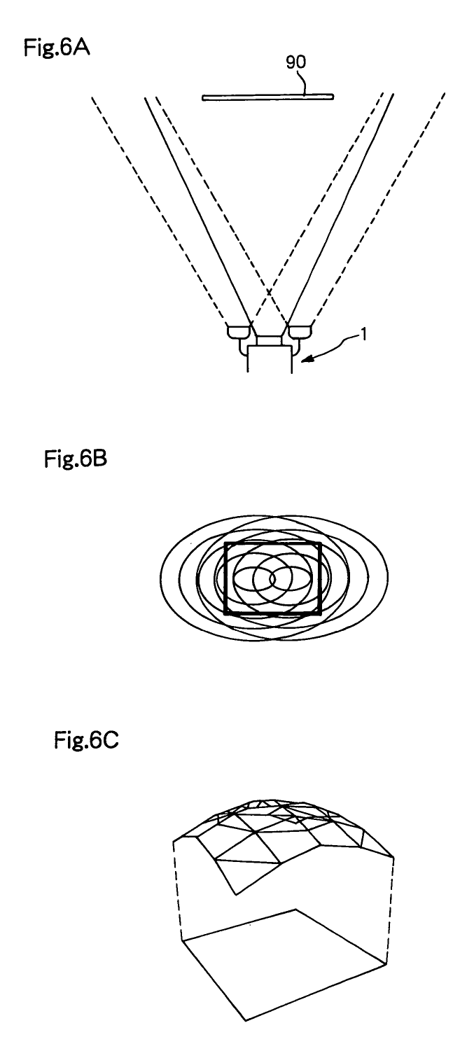

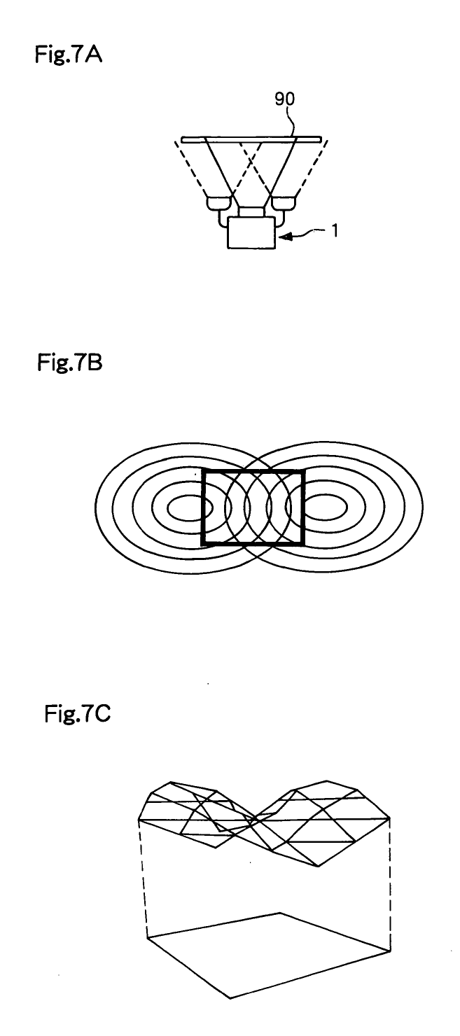

FIGS. 6A to 7C are views showing the illumination states of the object during flash photographing. FIGS. 6A to 6C show a case wherein the distance to the object is relatively large, and FIGS. 7A to 7C show a case wherein the distance to the object is relatively small. In addition, these views also show cases wherein all of the light emission sections 7a are aimed in a direction parallel to the optical axis L and the central light of the flashlight is thus emitted in parallel to the optical axis L.

First, when the distance from the image-taking apparatus 1 to the object 90 is relatively large as shown in FIG. 6A, the illumination state of the flashlight on the surface of the object 90 is as shown in FIG. 6B. FIG. 6B indicates that the central portions of the concentric ellipses are bright and that the peripheral portions thereof are dark. FIG. 6C is a three-dimensional view of this illuminance distribution on the surface of the object 90. As understood from the illuminance distribution of FIG. 6C, when the distance from the image-taking apparatus 1 to the object 90 is relatively large, the central portion of the object 90 is illuminated properly by the flashlight, and no particular problems occur.

On the other hand, when the distance from the image-taking apparatus 1 to the object 90 is relatively small as shown in FIG. 7A, the illumination state of the flashlight on the surface of the object 90 is as shown in FIG. 7B. Hence, the flashlight emitted from the light emission sections 7a mainly illuminates the peripheral portion of the object 90. FIG. 7C is a three-dimensional view of the illuminance distribution on the surface of the object 90.

As understood from the illuminance distribution of FIG. 7C, when the distance from the image-taking apparatus 1 to the object 90 is relatively small, the central portion of the object 90 is not illuminated properly by the flashlight, and underexposure occurs at the central portion of the image, whereby a dark image is obtained. In the case of short-distance photographing in particular, the main portion of the object is frequently disposed at the central portion of the image, whereby there is a high possibility that an optimum image is not obtained. This phenomenon becomes more conspicuous as the distance from the image-taking apparatus 1 to the object 90 is smaller.

Hence, after the object distance DV based on the corrected distance information Xc is obtained, the photographing control section 20 makes a judgment as to whether or not the object distance DV is the predetermined value or less. When the distance DV is the predetermined value or less, the flashlight emission amount IV is corrected depending on the object distance DV to prevent underexposure at the center of the image.

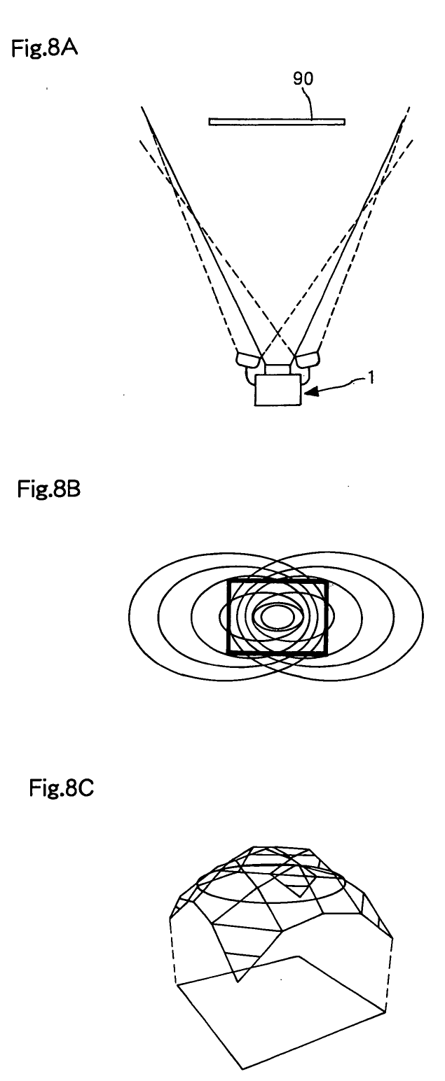

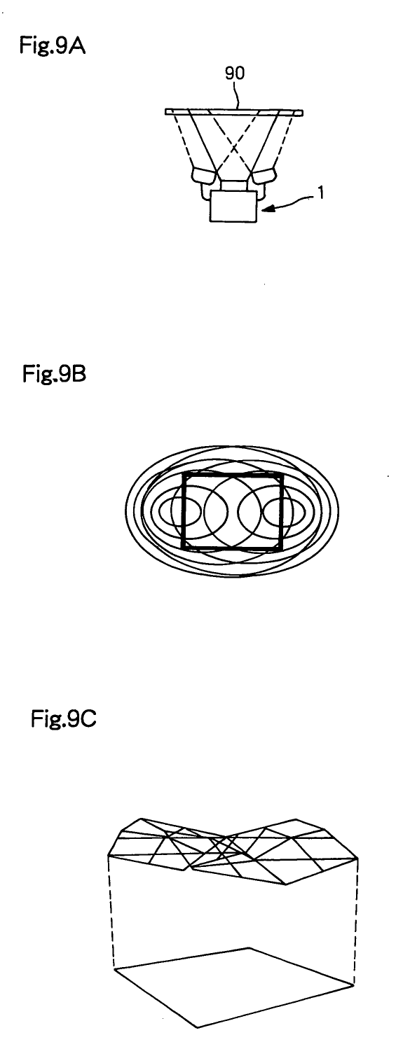

Furthermore, the flashlight illumination state at the object 90 changes depending on the installation angle of the light emission sections 7a. FIGS. 8A to 9C are views showing the illumination states of the object during flash photographing. FIGS. 8A to 8C show a case wherein the distance to the object is relatively large, and FIGS. 9A to 9C show a case wherein the distance to the object is relatively small. In addition, these views also show cases wherein all of the light emission sections 7a are tilted inward and thus the central light of the flashlight intersects with the optical axis L at a certain point.

When the distance from the image-taking apparatus 1 to the object 90 is relatively large as shown in FIG. 8A, the illumination state of the flashlight on the surface of the object 90 is as shown in FIG. 8B. FIG. 8C is a three-dimensional view of the illuminance distribution on the surface of the object 90. As understood from the illuminance distribution of FIG. 8C, when the distance from the image-taking apparatus 1 to the object 90 is relatively large, the central portion of the object 90 is illuminated properly by the flashlight, and no particular problems occur even in this case.

On the other hand, when the distance from the image-taking apparatus 1 to the object 90 is relatively small as shown in FIG. 9A, the illumination state of the flashlight on the surface of the object 90 is as shown in FIG. 9B. In other words, the flashlight emitted from the light emission sections 7a mainly illuminates the peripheral portion of the object 90. FIG. 9C is a three-dimensional view of the illuminance distribution on the surface of the object 90.

As understood from the illuminance distribution of FIG. 9C, even when the light emission sections 7a are tilted inward to some extent, when the installation angle is small, as the distance from the image-taking apparatus 1 to the object 90 becomes small, the central portion of the object 90 is not illuminated properly by the flashlight, and underexposure occurs at the central portion of the image, whereby a dark image is obtained. Hence, there is a high possibility that an optimal image is not obtained even in this case of short-distance photographing.

To solve this problem, the photographing control section 20 in accordance with this embodiment is configured to correct the flashlight emission amount IV depending on the above-mentioned object distance DV and to adjust its correction amount ΔIV depending on the installation angle of the light emission sections 7a. More specifically, the photographing control section 20 reads the emission amount correction LUT 22b from the memory 22 and determines the correction amount ΔIV on the basis of the installation angle of the light emission sections 7a and the object distance DV.

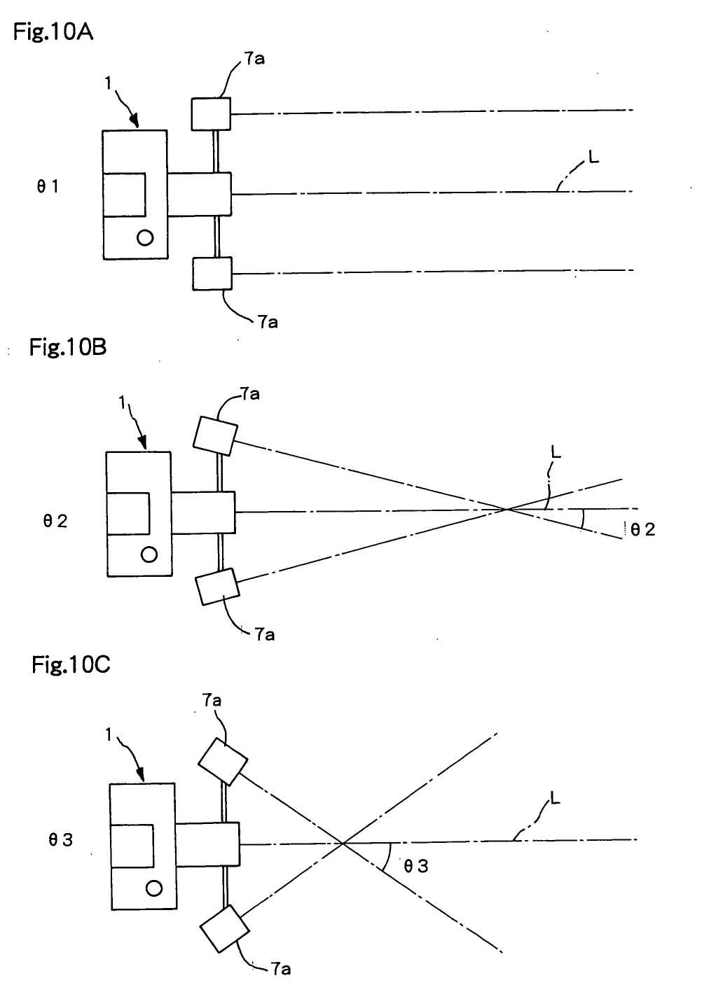

FIGS. 10A to 10C are views showing the change in the installation angle of the light emission sections 7a of the image-taking apparatus 1 and also showing cases wherein the installation angle of the light emission sections 7a can be adjusted in three steps. FIG. 10A shows a case wherein the installation angle of the light emission sections 7a is θ1 (in other words, the flashlight is emitted in a direction parallel to the optical axis L). FIG. 10B shows a case wherein the installation angle of the light emission sections 7a is θ2. Furthermore, FIG. 10C shows a case wherein the installation angle of the light emission sections 7a is θ3. A relationship of θ1<θ2<θ3 is established among these angles.

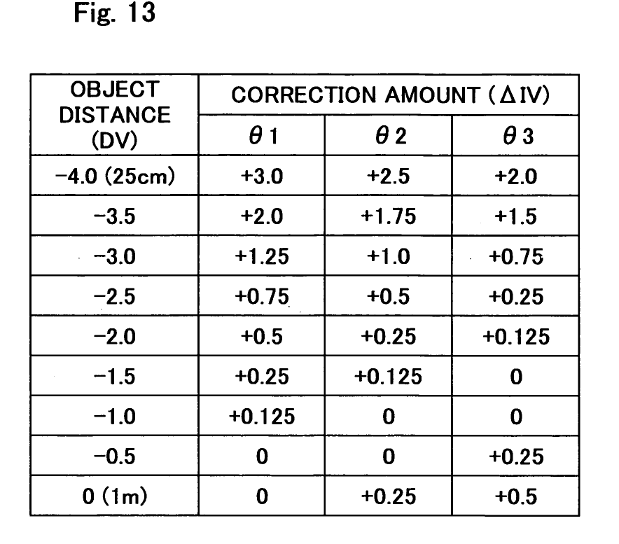

When the installation angle of the light emission sections 7a is adjustable in three steps as shown in FIGS. 10A to 10C, the correction amount ΔIV is obtained in advance by experiment or the like, and data as shown in FIG. 13 is stored in the emission amount correction LUT 22b of the memory 22.

When the object distance DV represented according to APEX becomes 0 or less as shown in FIG. 13 in this embodiment, processing for correcting the flashlight emission amount IV is carried out. However, when the correction amount ΔIV is 0 in FIG. 13, the correction processing is not substantially carried out.

In FIG. 13, when attention is paid to the case wherein the installation angle is θ1 and when the object distance DV represented according to APEX becomes −1.0 or less, the correction amount ΔIV for correcting the flashlight emission amount IV is determined to be an effective value, and substantial correction processing is carried out. As the object distance DV is smaller, that is, as the distance to the object is smaller, the correction amount ΔIV becomes larger gradually, and the flashlight emission amount IV increases. As a result, in short-distance photographing, the illuminance at the center of the image can be raised, and the central portion of the image can be photographed at proper exposure.

Next, when attention is paid to the case wherein the installation angle is θ2 and the case wherein the installation angle is θ3, as the installation angle of the light emission sections 7a becomes larger, the object located in a short distance can be illuminated more properly, whereby the correction amount ΔIV is determined depending on the installation angle.

Instead of the data shown in FIG. 13, parameters for calculating the respective correction amounts ΔIV may be stored in the emission amount correction LUT 22b, and the arithmetic operation section 21 may calculate the correction amounts ΔIV by carrying out arithmetic processing using the parameters.

When the correction amount ΔIV depending on the installation angle of the light emission sections 7a and the object distance DV is determined referring to the emission amount correction LUT 22b as shown in FIG. 13 described above, the photographing control section 20 determines the flashlight emission amount IV of the light emission sections 7a, the aperture value AV of the aperture diaphragm 30 or the sensitivity SV corresponding to the gain of the AGC circuit 12 so that the following relationship:
IV=AV+DV−SV+5+ΔIV (3)
is established. On the basis of the respective values, the photographing control section 20 carries out settings for the flash control section 8, the aperture driver 25 and the AGC circuit 12, and controls flash photographing in response to the full-pressing operation of the shutter button 4.

Hence, in the short-distance flash photographing, the problem of the reduction in illuminance at the central portion of the image owing to the unevenness in flashlight distribution can be solved, and an image whose central portion is exposed properly can be obtained.

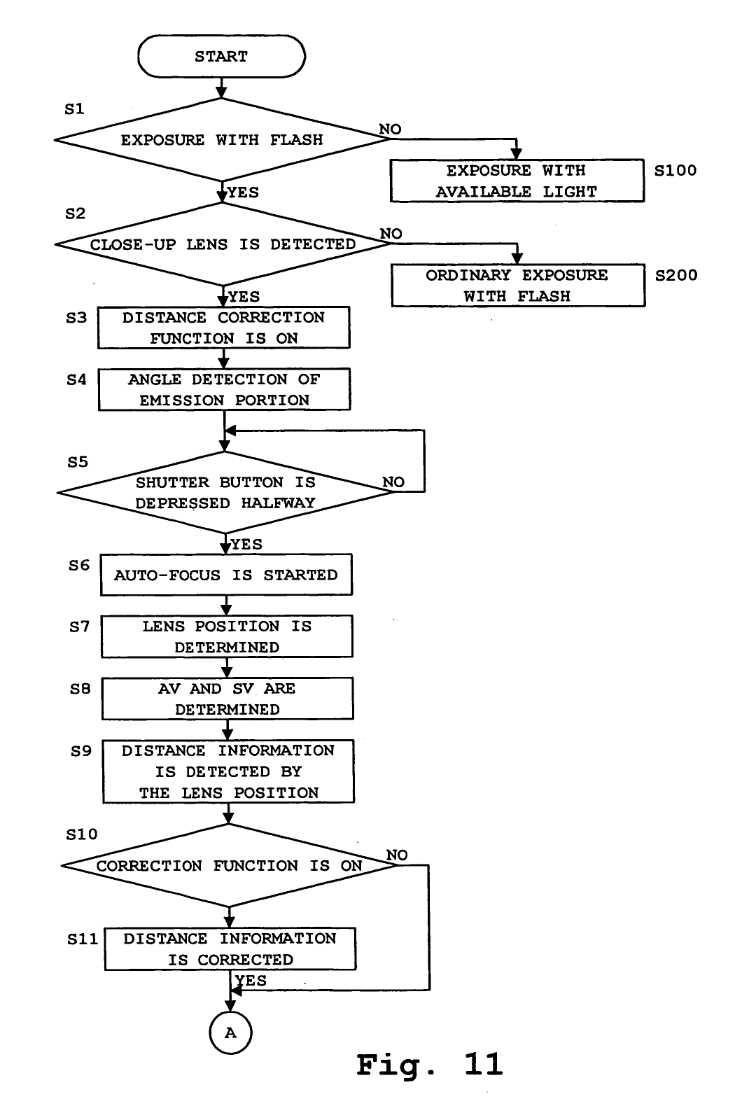

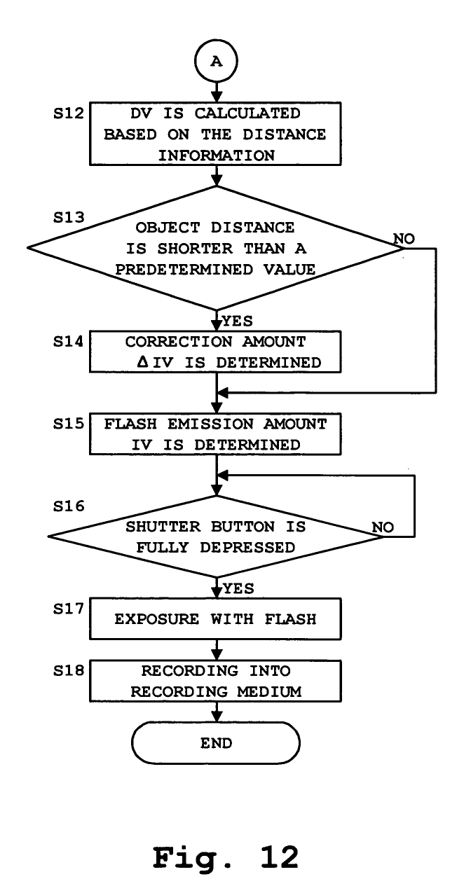

Next, the operation procedure of the image-taking apparatus 1 will be described referring to flowcharts shown in FIGS. 11 and 12.

First, when the power of the image-taking apparatus 1 is turned on, the photographing control section 20 makes a judgment as to whether flash photographing is turned on or not, on the basis of the setting operation by the user (at step S1). When the flash photographing is not turned on, the procedure advances to step S100. At step S100, flashlight emission is not carried out, but photographing using available light is carried out. Since known technologies can be used for the photographing using available light at step S100, the specific processing contents thereof are not described herein.

On the other hand, when the flash photographing is turned on, the procedure advances to step S2, and the photographing control section 20 makes a judgment as to whether the close-up lens 6 is detected by the mounting detection section 28 or not. When the close-up lens 6 is not mounted, the procedure advances to step S200. At step S200, ordinary flash photographing for photographing the object located in the range from the most proximal position to the infinite distance is carried out under the flashmatic control.

Alternatively, at step S200, preliminary light emission may be carried out to determine the flashlight emission amount and the like and then flash photographing under light control may be carried out. Since known technologies can be used for the ordinary flash photographing at step S200, the specific processing contents thereof are not described herein.

Furthermore, when the close-up lens 6 is detected at step S2, the procedure advances to step S3, and the distance information correction function of the arithmetic operation section 21 is turned on. Moreover, at this time, the flashmatic control is set as the method for controlling the flash photographing.

Next, the photographing control section 20 detects the installation angle θ of the light emission sections 7a on the basis of the angle information input from the angle detection section 35 (at step S4).

The photographing control section 20 then makes a judgment as to whether the shutter button 4 is set in its half-pressed state by the user or not (at step S5). When the half-pressing operation is carried out, automatic focusing is started in response to the operation (at step S6). At this time, the photographing control section 20 drives the focusing lens unit 31 stepwise at predetermined pitches along the optical axis L and identifies the position wherein the contrast regarding the image components in the focus region becomes the maximum. Then, the lens position wherein the object image is brought into an in-focus state by automatic focusing is determined (at step S7). When manual focusing is carried out, the user operates the focusing ring 3a to move the focusing lens unit 31, whereby the position of the lens being set is determined.

At this time, photometry for automatic exposure control (AE) is also carried out, and the aperture value AV and the sensitivity SV according to APEX are determined (at step S8). It is assumed that the exposure time (shutter speed) of the image-taking device 10 is set at a predetermined value in advance at the time when the result of the judgment at step S1 is YES.

The photographing control section 20 obtains the distance information based on the lens position of the focusing lens unit 31 at the present moment from the distance measuring section 29 (at step S9). The distance information obtained at this time is distance information obtained depending on only the optical characteristics of the taking lens 3 and is distance information in the range from the most proximal position to the infinite distance.

Hence, the photographing control section 20 makes a judgment as to whether the distance information correction function has been turned on or not (at step S10). When the distance information correction function has been turned on at step S3, the result of the judgment is YES at step S10. The procedure then advances to step S11, and the arithmetic operation section 21 operates to calculate accurate distance information in the state wherein the close-up lens 6 is mounted, on the basis of the information read from the mounted lens LUT 22a and the distance information input from the distance measuring section 29.

The procedure advances to the flowchart shown in FIG. 12, and the photographing control section 20 calculates the object distance DV represented according to APEX on the basis of the distance information (at step S12) When the correction operation at step S11 has been carried out, the object distance DV is calculated on the basis of the corrected distance information, whereby the object distance DV to the object located in the short distance region is obtained accurately.

At step S13, the photographing control section 20 makes a judgment as to whether or not the object distance DV calculated at step S12 is the predetermined value or less. When the emission amount correction LUT 22b as shown in FIG. 13 is used, a judgment is made at this time as to whether or not the object distance DV is 0 or less (in other words, the actual distance to the object is one meter or less). When the object distance DV is the predetermined value or less as the result of this judgment, the procedure advances to step S14 to solve the problem of the reduction in illuminance at the central portion of the image owing to the unevenness in flashlight distribution by the light emission sections 7a. On the other hand, when the object distance DV is not the predetermined value or less, step S14 is skipped and the procedure advances to step S15.

At step S14, the photographing control section 20 obtains the emission amount correction LUT 22b from the memory 22 and determines the correction amount ΔIV on the basis of the object distance DV calculated at step S12 and the installation angle θ of the light emission sections 7a detected at step S4 referring to the emission amount correction LUT 22b.

Then, at step S15, the photographing control section 20 determines the flashlight emission amount IV on the basis of the object distance DV. When the processing at step S14 described above has been carried out at this time, the flashlight emission amount IV is determined on the basis of the object distance DV and the correction amount ΔIV so as to satisfy the relationship of the above-mentioned mathematical expression 3. Hence, in this case, the flashlight emission amount IV determined by the ordinary flashmatic control is corrected to a larger value depending on the object distance DV.

On the other hand, when the processing at step S14 described above is not carried out, the flashlight emission amount IV is determined on the basis of the object distance DV so as to satisfy the relationship of the above-mentioned mathematical expression 1. Hence, in this case, the flashlight emission amount IV is determined by the ordinary flashmatic control.

Then, at step S15, when the flashlight emission amount IV by the light emission sections 7a is determined, an instruction indicating the light emission amount is issued from the photographing control section 20 to the flash control section 8.

When the flashlight emission amount IV is a predetermined lower limit value or less at step S15, the light emission amount IV is fixed at the lower limit value, and one or both of the aperture value AV and the sensitivity SV are readjusted so as to satisfy the relationship of the mathematical expression 1 or the mathematical expression 3.

Then, a judgment is made as to whether the shutter button 4 is set in the fully-pressed state by the user or not (at step S16). When the full-pressing operation is carried out, flash photographing for image recording is carried out in response to the operation (at step S17). In other words, the photographing control section 20 carries out driving so that the aperture diameter of the aperture diaphragm 30 matches the aperture value AV.

Furthermore, the photographing control section 20 sets the gain of the AGC circuit 12 so as to match the sensitivity SV, issues a photographing instruction to the timing generator 27 and then transmits a flashlight emission instruction to the flash control section 8. At this time, the flash control section 8 causes the light emission sections 7a to emit light at the light emission amount IV instructed by the photographing control section 20.

The image signal stored in the image memory 14 as the result of the photographing is subjected to image processing, such as compression processing, by the image-processing circuit 15, recorded on the recording medium 18, and the photographing processing is completed (at step S18).

As described above, the image-taking apparatus 1 in accordance with this embodiment is configured to carry out the flashmatic control at the time when flash photographing is carried out in a short distance. When the distance to the object is the predetermined value or less, correction is carried out so that the light emission amount is made larger than the flashlight emission amount determined by the ordinary flashmatic control, and then flash photographing is carried out. Therefore, the central portion of the image is prevented from becoming dark in short-distance flash photographing, whereby a proper image can be obtained.

In addition, in the above-mentioned image-taking apparatus 1, the correction amount at the time when the distance to the object is the predetermined value or less is set at an optimum value based on the distance. Hence, the illuminance reduction phenomenon at the central portion of the image owing to the change in the distance to the object can be corrected properly, whereby excellent images can be obtained at all times regardless of the position of the object in the short distance region.

Furthermore, in the above-mentioned image-taking apparatus 1, the installation angle of the light emission sections 7a with respect to the optical axis L of the taking lens 3 is adjustable, and the correction amount at the time when the distance to the object is the predetermined value or less is changed further depending on the installation angle. Hence, the illuminance reduction phenomenon at the central portion of the image owing to the change in the installation angle of the light emission sections 7a can also be corrected properly, whereby excellent images can be obtained at all times regardless of the installation angle of the light emission sections 7a.

Moreover, in the above-mentioned image-taking apparatus 1, the multiple light emission sections 7a are disposed around the optical axis L so as to be equidistant from the optical axis L, whereby the object located in the short distance region can be illuminated nearly uniformly from around its circumference. In short-distance flash photographing in particular, the unevenness in illumination of the object is apt to become conspicuous. However, by uniformly disposing the multiple light emission sections 7a around the optical axis L as in this embodiment, the unevenness in illumination is suppressed, and the object can be photographed in an excellent state.

Still further, in the above-mentioned image-taking apparatus 1, the distance to the object is detected depending on the object's focus state obtained via the taking lens 3 and the close-up lens 6, whereby the distance to the object can be detected accurately using a relatively simple configuration.

Although an embodiment in accordance with the present invention has been described above, the present invention is not limited to the above-mentioned embodiment.

In the above-mentioned embodiment, for example, a configuration is exemplified wherein the flashlight emission amount IV is preferentially determined mainly by the flashmatic control, and the aperture value AV or the sensitivity SV is adjusted when the light emission amount IV is the predetermined lower limit value or less. However, since it is supposed in some cases that the flashlight emission amount by the light emission sections 7a is constant at all times and that the adjustment of the light emission amount is impossible. Hence, when the flashlight emission amount IV cannot be adjusted, the light emission amount IV should only be set at a fixed value, and at least one of the aperture value AV and the sensitivity SV should only be adjusted so as to satisfy the relationship of the mathematical expression 1 or the mathematical expression 3.

In other words, when the distance to the object is the predetermined value or less, instead of the light emission amount of the light emission sections 7a, the aperture diameter of the aperture diaphragm 30 or the gain value applied to the image signal obtained from the image-taking device 10 may be corrected so as to be larger than the value determined by the flashmatic control, and flash control may be carried out accordingly.

In addition, in the above-mentioned embodiment, a configuration is exemplified wherein the aperture diaphragm 30 is provided as an aperture stop, and the light rays are controlled by adjusting the aperture diameter of the aperture diaphragm 30. However, the aperture stop is not limited to the above-mentioned aperture diaphragm.30, and the aperture stop itself is not required to be movable. For example, the device may have a fixed configuration for only restricting the light rays. Furthermore the device may use a neutral density (ND) filter that is inserted into or removed from the optical path to substantially control the light amount.

Furthermore, in the above-mentioned descriptions, the fact that a correction coefficient is calculated from the DV value and at least one of the light emission amount, the aperture value and the gain is corrected is described. However, for example, a low-priced camera is available in which its flashlight emission section is built in its camera body 2, and the aperture value and the like cannot be changed. Such a camera may be configured so as to obtain the flashlight emission amount IV or the like directly corrected from the object distance DV on the basis of the object distance DV referring to the emission amount correction LUT 22b. Since no arithmetic processing is necessary in this case, it is possible to provide a relatively low-priced camera.

Moreover, in the above-mentioned embodiment, a configuration is exemplified wherein the necessity of correcting the light emission amount IV or the like is judged depending on whether or not the object distance DV represented according to APEX and obtained by the photographing control section 20 is the predetermined value or less. However, the present invention is not limited to this configuration. For example, when the close-up lens 6 is mounted on the taking lens 3, the photographable range of the image-taking apparatus 1 is restricted within the short distance region by the close-up lens 6. Hence, the necessity of correcting the light emission amount IV or the like may be judged by knowing the mounting. In other words, the apparatus may be configured so that when the mounting of the close-up lens 6 is detected, the result of the judgment at step S13 of FIG. 12 is YES.

Still further, in the above-mentioned embodiment, a configuration is exemplified wherein the close-up lens 6 is mounted on the taking lens 3. However, whether the close-up lens 6 is mounted or not is optional, and even when flash photographing is carried out in a short distance using only the taking lens 3, a similar technology can be used.

Still further, in the above-mentioned embodiment, a configuration is exemplified wherein the installation angle of the light emission sections 7a is automatically detected by the angle detection section 35. However, the present invention is not limited to this configuration. For example, the installation angle of the light emission sections 7a may be input manually by the user who operates the operation section 24 referring to a menu displayed on the liquid crystal display 17 or the like. In this case, the photographing control section 20 obtains the correction amount ΔIV on the basis of the installation angle of the light emission sections 7a, the installation angle having been input by the user's operation.

Still further, in the above-mentioned embodiment, a configuration is exemplified wherein the correction amount ΔIV at the time when the distance to the object is the predetermined value or less is changed depending on the installation angle of the light emission sections 7a with respect to the optical axis L. However, even if the installation angle of the light emission sections 7a is not changed, if the installation positions of the light emission sections 7a are changed, the illumination state of the object is changed to a different state accordingly.

Hence, when the installation positions of the light emission sections 7a in the image-taking apparatus 1 are changeable, the correction amount ΔIV is desired to be optimized also depending on the installation positions of the light emission sections 7a. In this case, the installation positions of the light emission sections 7a may be detected automatically or the information on the positions may be input manually.

Furthermore, the correction amount ΔIV obtained by experiment or the like in advance depending on the installation positions of the light emission sections 7a should only be stored in the emission amount correction LUT 22b, and the correction amount ΔIV depending on the installation positions should only be determined referring to the emission amount correction LUT 22b.

Still further, in the above-mentioned embodiment, a configuration is exemplified wherein the focus state of the taking lens 3 is judged depending on the contrast of a photographed image. However, the present invention is not limited to this configuration. For example, it is possible to adopt a configuration wherein a phase difference sensor of the TTL (through the lens) type or the like is provided separately, and the focus state of the object image is judged to judge the focus state of the taking lens 3.

Still further, in the above-mentioned embodiment, a configuration is exemplified wherein the distance detection section 29 detects the distance to the object depending on the position of the focusing lens unit 31 included in the taking lens 3. However, the present invention is not limited to this configuration. For example, the distance detection section 29 may be configured so as to function regardless of the operation of the taking lens 3 and to operate as a distance measurement sensor for receiving the light from the object without using the taking lens 3 and for calculating the distance to the object. In this case, even when the close-up lens is mounted, it is not necessary to correct the distance information, whereby efficient processing can be carried out.

Still further, in the above-mentioned embodiment, a configuration is exemplified wherein the electronic flash device 7 is installed outside the camera body 2. However, the electronic flash device 7 may be built inside the camera body 2. In addition, the light emission sections 7a may be installed on the barrel of the taking lens 3 or the close-up lens 6.

Still further, in the above-mentioned embodiment, a configuration is described wherein the two light emission sections 7a are provided. However, the above described technique is also applicable to a configuration having one light emission section 7a. In other words, since the light emission section 7a cannot emit flashlight on the optical axis L owing to the structure of the image-taking apparatus 1, it is known that optimum exposure is not obtained at the central portion of the image as described above during short-distance photographing even when one light emission section 7a is used. Hence, even in the image-taking apparatus having one light emission section, excellent images can be obtained during short-distance photographing.

The above-mentioned image-taking apparatus is configured to carry out flash photographing under the flashmatic control. When the distance to the object, detected by the distance measuring device, is the predetermined value or less, at least one of the light emission amount of the light emission device, the aperture diameter of the aperture stop and the gain applied to the image signal obtained from the image-taking device is corrected to a value larger than the value determined by the flashmatic control, and flash photographing is carried out. Hence, even when the object is in a short distance, photographing can be carried out while the unevenness in light distribution by the light emission sections is suppressed and optimum brightness is provided at the central portion of the image.

Still further, in the above-mentioned image-taking apparatus, when the distance to the object, detected by the distance measuring device, is the predetermined value or less, a correction amount for at least one of the light emission amount, the aperture diameter and the gain is determined on the basis of the distance, whereby the illuminance reduction phenomenon at the central portion of the image owing to the change in the distance to the object can be corrected properly, and excellent images can be obtained at all times regardless of the position of the object in the short distance region.

Still further, in the above-mentioned image-taking apparatus, the correction amount is changed depending on the installation position or the installation angle of the light emission device with respect to the optical axis of the optical system, whereby the illuminance reduction phenomenon at the central portion of the image owing to the change in the installation position or the installation angle of the light emission device can be corrected properly, and excellent images can be obtained at all times regardless of the installation position or the installation angle of the light emission device.

Still further, in the above-mentioned image-taking apparatus, the light emission device wherein the multiple light emission sections are disposed around the optical axis of the optical system so as to be equidistant from the optical axis is used, whereby the object located in the short distance region can be illuminated nearly uniformly from around its circumference. In short-distance flash photographing in particular, the unevenness in light distribution of the object is apt to become conspicuous. However, by uniformly disposing the multiple light emission sections around the optical axis, the unevenness in light distribution is suppressed, and the object can be photographed in an excellent state.

Still further, in the above-mentioned image-taking apparatus, the distance measuring device is configured to detect the distance to the object depending on the object's focus state obtained via the optical system, whereby the distance to the object can be detected accurately using a relatively simple configuration.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An image-taking apparatus being configured to carry out flash photographing under flashmatic control, the image-taking apparatus comprising:
an optical system, having an aperture stop, for leading the light from the object to an image-taking device;
a distance measuring device for detecting the distance to the object;
a light emission device for emitting flashlight; and
a controller which controls the image-taking apparatus for carrying out flash photographing so that, when the distance to the object, detected by the distance measuring device, is a predetermined value or less, at least one of the light emission amount of the light emission device, the aperture diameter of the aperture stop and the gain applied to the image signal obtained from the image-taking device is corrected to a value larger than the value determined by the flashmatic control.

2. An image-taking apparatus according to claim 1, wherein;
when the distance to the object, detected by the distance measuring device, is the predetermined value or less, amount of the correction for at least one of the light emission amount of the light emission device, the aperture diameter of the aperture stop and the gain applied to the image signal obtained from the image-taking device is determined on the basis of the distance.

3. An image-taking apparatus according to claim 2, wherein;
the installation position or angle of the light emission device with respect to the optical axis of the optical system is adjustable, and
the correction amount is changed depending on the installation position or angle of the light emission device.

4. An image-taking apparatus according to claim 1, wherein,
the light emission device is provided with a multiple light emission sections and the multiple light emission sections are disposed around the optical axis of the optical system so as to be equidistant from the optical axis.

5. An image-taking apparatus according to claim 1, wherein,
the distance measuring device detects the distance to the object depending on a position of a focusing lens unit of the optical system.

6. An image-taking apparatus being configured to carry out flash photographing under flashmatic control in cooperation with a light emission device for emitting flashlight, the image-taking apparatus comprising:
an optical system, having an aperture stop, for leading the light from the object to an image-taking device;
a distance measuring device for detecting the distance to the object;
a controller which controls the image-taking apparatus for carrying out flash photographing so that, when the distance to the object, detected by the distance measuring device, is a predetermined value or less, at least one of the light emission amount of the light emission device, the aperture diameter of the aperture stop and the gain applied to the image signal obtained from the image-taking device is corrected to a value larger than the value determined by the flashmatic control.

7. An image-taking apparatus according to claim 6, wherein;
when the distance to the object, detected by the distance measuring device, is the predetermined value or less, amount of the correction for at least one of the light emission amount of the light emission device, the aperture diameter of the aperture stop and the gain applied to the image signal obtained from the image-taking device is determined on the basis of the distance.

8. An image-taking apparatus according to claim 7, wherein;
the installation position or angle of the light emission device with respect to the optical axis of the optical system is adjustable, and
the correction amount is changed depending on the installation position or angle of the light emission device.

9. An image-taking apparatus according to claim.6, wherein,
the light emission device is provided with a multiple light emission sections and the multiple light emission sections are disposed around the optical axis of the optical system so as to be equidistant from the optical axis.

10. An image-taking apparatus according to claim 6, wherein,
the distance measuring device detects the distance to the object depending on a position of a focusing lens unit of the optical system.
